(19) United States
(12) Patent Application Publication
(10) Pub. No.: US 2012/0067168 A1
(43) Pub. Date: Mar. 22, 2012

(54) MULTI-STAGE POSITIONING ROTARY DISK

(76) Inventor: Wen-Hsuan CHIANG, Taichung City (TW)

(21) Appl. No.: 12/886,574

(22) Filed: Sep. 21, 2010

(51) Int. Cl. F16D 71/04

(52) U.S. Cl. 74/813 R

(57) ABSTRACT

A multi-stage positioning rotary disk includes an inner disk and an outer disk hinged on the inner disk and turnable thereon. The inner disk has at least one latch cavity to hold a latch member elastically extended outwards from the latch cavity. The outer disk has a plurality of positioning slots latched with the latch member. Each positioning slot is formed from a greater depth to a smaller depth according to turning direction of the outer disk. Hence the latch member is latched sequentially on the positioning slots during relative turning between the outer disk and inner disk to allow the outer disk to provide staged positioning function. The structure is simpler and staged positioning is easy to operate when in use, and durability is enhanced and production cost is lower.

### FIELD OF THE INVENTION

The present invention relates to a rotary disk and particularly to a multi-stage positioning rotary disk.

### BACKGROUND OF THE INVENTION

A conventional magnetic working platform includes a seat and a rotary magnet functioned cooperatively. Through a rotary knob connected with the rotary magnet, the rotary magnet can be controlled to turn about 180 degrees to provide two functions of attraction and non-attraction of the magnetic working platform. With advance of technology, now the magnet working platform can be turned in multiple stages at different angles to adjust the intensity of magnetic force of the working platform, or set the magnetic force in varying directions.

However, the conventional rotary knob does not provide staged positioning function, hence is difficult to control the rotary magnet to turn in multi-stage angles. Although multi-stage rotary disk has been proposed in prior art, it generally has complex structure and is easily damaged. It also is costly to fabricate, thus is not desirable to be adapted to magnetic working platforms.

### SUMMARY OF THE INVENTION

Therefore, the primary object of the present invention is to provide a multi-stage positioning rotary disk that is simply structured and adaptable to magnetic working platforms to control multi-stage positioning by turning.

The present invention aims to provide a multi-stage positioning rotary disk that includes an inner disk and an outer disk hinged on the inner disk and turnable thereon. The inner disk has at least one latch cavity to hold a latch member elastically extended outwards from the latch cavity. The outer disk has a plurality of positioning slots corresponding to the latch member and latchable therewith. Each positioning slot is formed from a greater depth to a smaller depth according to the turning direction of the outer disk. Hence the latch member is gradually turned from a compressed condition to a released condition in the positioning slot and finally moved out therefrom. As a result, the latch member of the inner disk is latched sequentially on the positioning slots with the relative turning between the outer disk and inner disk so that the outer disk can achieve staged positioning function during turning.

Thus through a simple structure of the outer disk being hinged on the inner disk, a staged positioning rotary disk can be formed, and not only production cost is reduced, a longer durability also can be achieved.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of an embodiment of the invention.

FIG. 2A is a sectional view of an embodiment of the invention in a turning condition.

FIG. 2B is a sectional view of an embodiment of the invention in a latched condition.

FIG. 2C is a sectional view of an embodiment of the invention in a removing condition.

FIG. 3 is a schematic view of another embodiment of the invention showing corresponding surfaces of an outer disk and an inner disk.

FIG. 4 is a schematic view of an embodiment of the invention showing marks on an outer disk.

FIG. 5 is a sectional view of yet another embodiment of the invention in an operating condition.

### DETAILED DESCRIPTION OF THE PREFERRED EMBODIMENTS

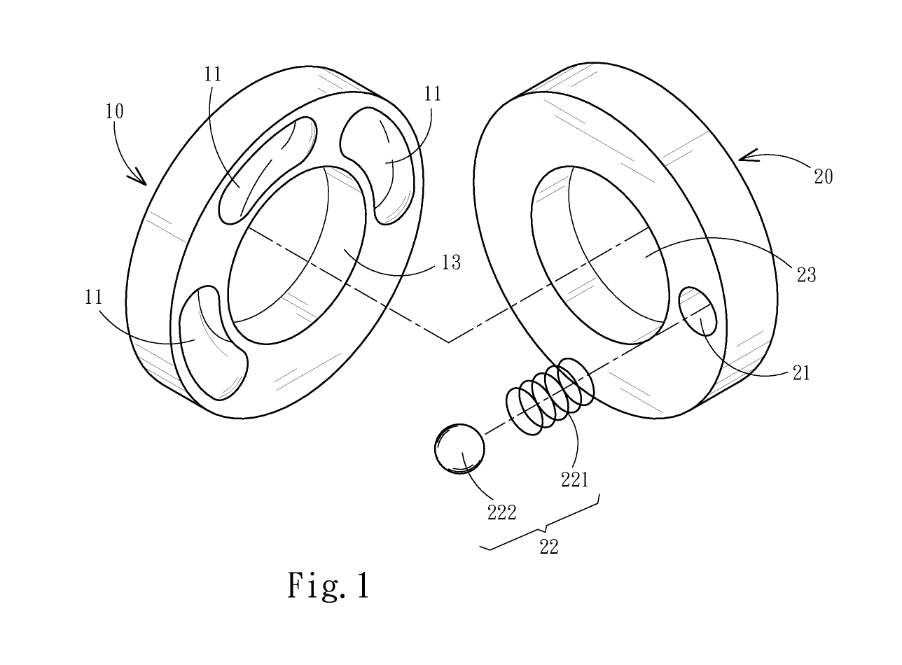

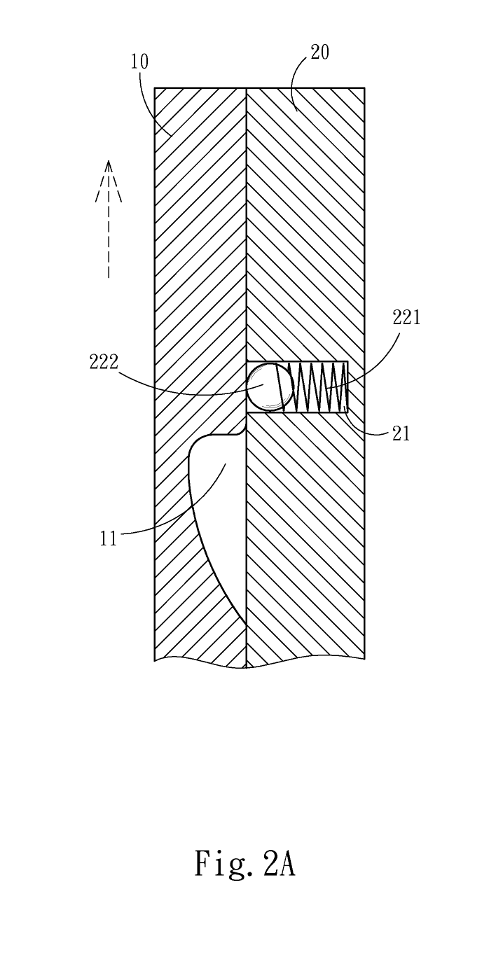

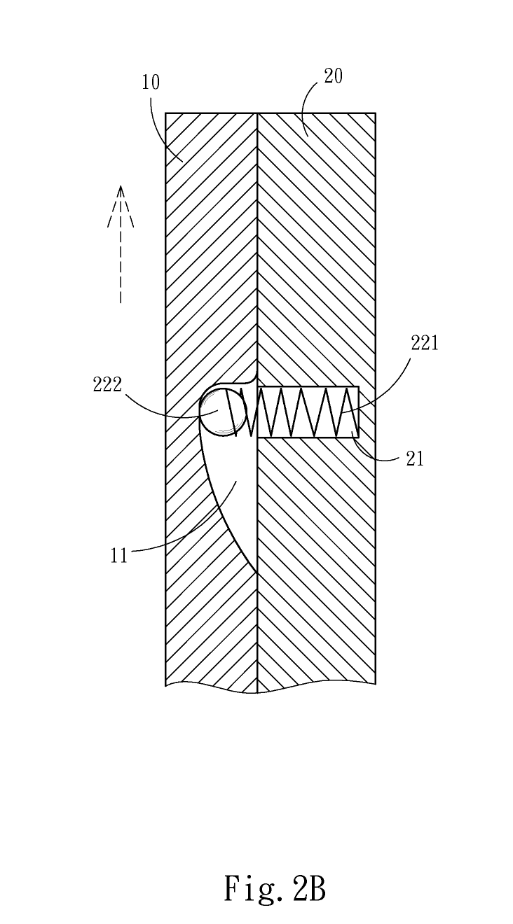

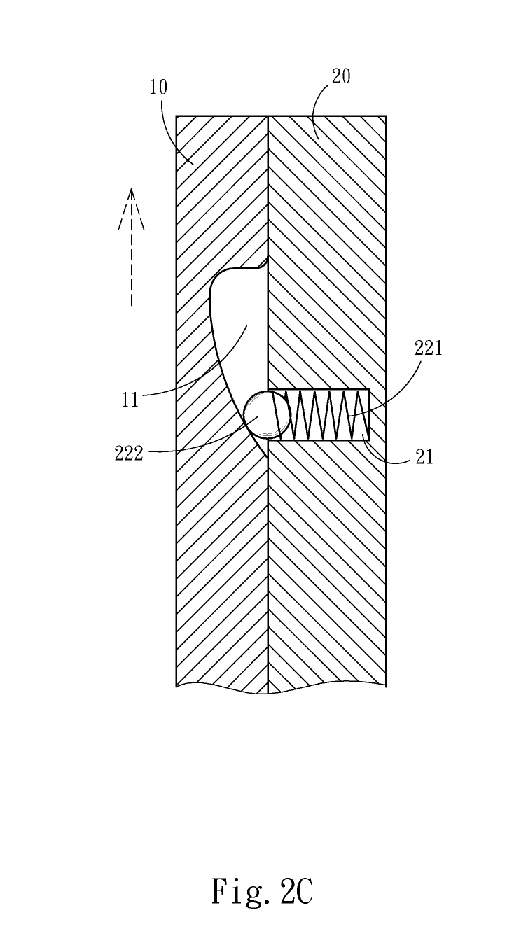

Please refer to FIGS. 1 through 2C for an embodiment of the multi-stage positioning rotary disk of the invention in various use conditions. It includes an inner disk 20 and an outer disk 10 hinged on the inner disk 20 and turnable thereon. The inner disk 20 has at least one latch cavity 21 to hold a latch member 22 elastically extended outwards from the latch cavity 21. In this embodiment, one latch cavity 21 is provided. The latch member 22 includes a spring 221 held in the latch cavity 21 and extended outwards, and a circular ball 222 butted by one end of the spring 221 extended outwards from the latch cavity 21. The outer disk 10 has a plurality of positioning slots 11 corresponding to the latch member 22 and latchable therewith. Each positioning slot 11 is formed from a greater depth to a smaller depth according to the turning direction of the outer disk 10.

When the outer disk 10 is turned, the positioning slots 11 also turn accordingly (referring to FIG. 2A), the latch member 22 first is latched with the positioning slot 11 at the deeper location to position the outer disk 10 (referring to FIG. 2B); as the outer disk 10 is turned further, the latched latch member 22 is moved gradually from the deeper location to the shallower location of the positioning slot 11 and compressed by the bottom of the positioning slot 11 (referring to FIG. 2C); finally the latch member 22 is moved out of the positioning slot 11. Hence, the latch member 22 of the inner disk 20 is latched on and moved out sequentially corresponding to the positioning slots 11 with the relative turning between the outer disk 10 and inner disk 20. As a result, the outer disk 10 can achieve staged positioning function during turning.

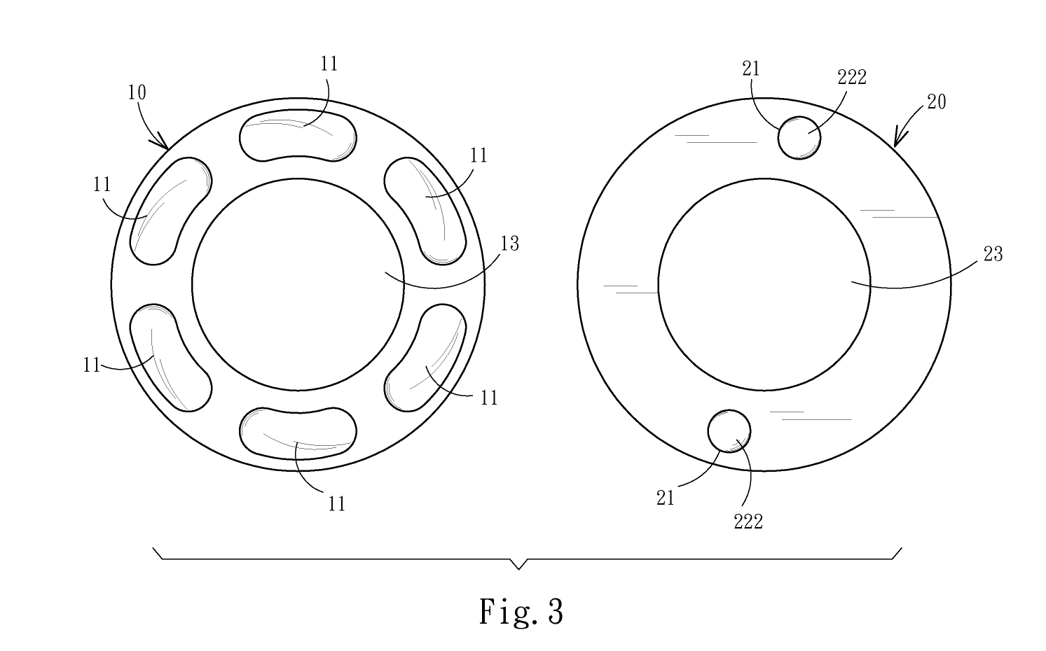

Refer to FIG. 3 for another embodiment of the invention with corresponding surfaces of the outer disk and inner disk. A plurality of latch cavities 21 are provided with a plurality of latch members 22 sequentially latched with corresponding positioning slots 11 while the outer disk 10 is turned relative to the inner disk 20. In this embodiment, the inner disk 20 has two latch cavities 21 to hold respectively a latch member 22. The outer disk 10 has six positioning slots 11 formed thereon. Each positioning slot 11 is formed in a depth from deeper to shallower according to the turning direction of the outer disk 10. It is to be noted that the two latch cavities 21 are arranged corresponding to the six positioning slots 11 with the two latch members 22 extended elastically outwards from the latch cavities 21, latched with two of the positioning slots 11 and moved out therefrom at the same time due to turning of the outer disk 10. In this embodiment, the six positioning slots 11 are arranged in a regular hexagon with the two latch cavities 21 located at two apexes opposing each other in a dichotomous manner. Therefore, not only the outer disk 10 can provide six stages, also can enhance positioning strength of the outer disk 10.

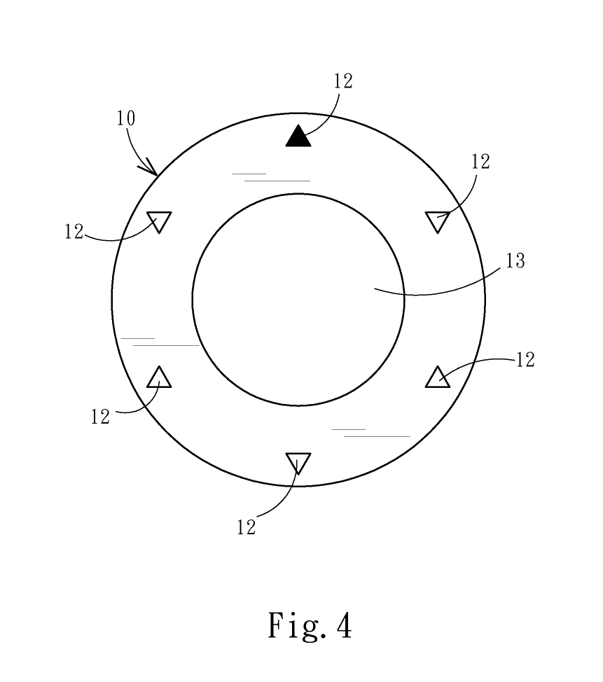

Refer to FIG. 4 for an embodiment of the outer disk 10 with marks formed thereon to facilitate positioning during turning. The outer disk 10 has scale marks 12 formed thereon to indicate turning positions. The scale marks 12 may be arranged on an outer surface. In this embodiment, the scale marks 12 are arranged on one side opposite to the positioning slots 11 and marked with different colors to indicate corresponding staged positioning locations.

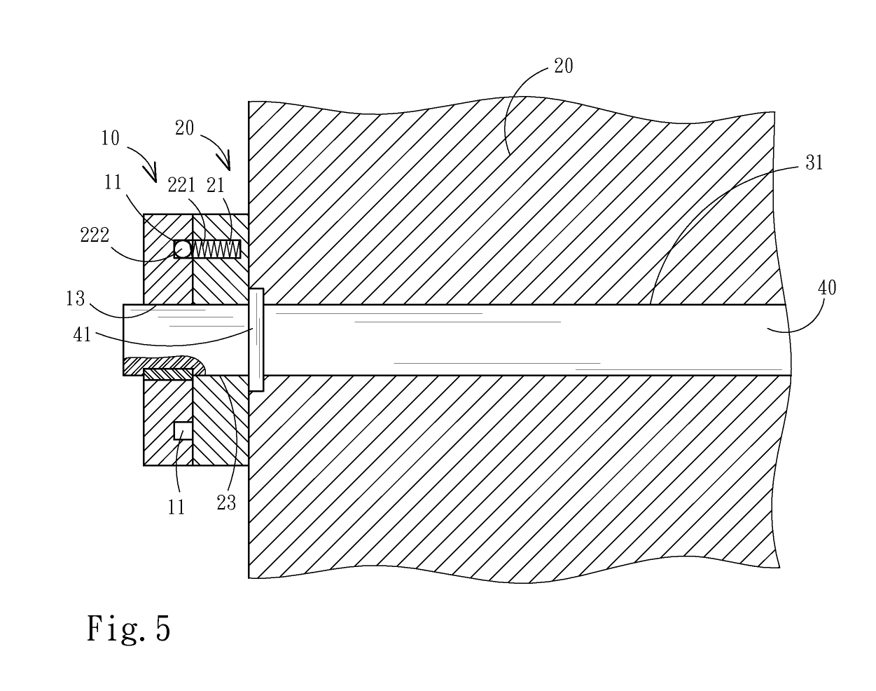

Refer to FIG. 5 for yet another embodiment of the invention in an operating condition. The inner disk 20 has a second hole 23 and is fastened to a seat 30. The seat 30 has a housing space 31. The outer disk 10 has a first hole 13. The outer disk 10 is fastened to a round column 40 through the first hole 13. The round column 40 runs through the second hole 23 and is held in the housing space 31. The round column 40 has a latch rim 41 for positioning turning locations between the inner disk 20 and the outer disk 10 so that the round column 40 can be turned with the outer disk 10 in the housing space 31 to provide staged positioning.

As a conclusion, through a simple structure of the outer disk 10 being hinged on the inner disk 20, a rotary disk with staged positioning function is formed. Not only production cost is lower, operation also is easier and durability is enhanced. By arranging multiple latch cavities 21 corresponding to multiple positioning slots 11 latched therewith and moved out therefrom at the same time, not only the staged function can be maintained, the positioning strength of the rotary disk also is enhanced. It provides a significant improvement over the conventional technique.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A multi-stage positioning rotary disk, comprising:
an inner disk including at least one latch cavity which holds a latch member elastically extended outwards therefrom; and
an outer disk which is hinged on the inner disk and turnable thereon including a plurality of positioning slots latched with the latch member, each positioning slot being formed from a greater depth to a smaller depth according to turning direction of the outer disk.

2. The multi-stage positioning rotary disk of claim 1, wherein the latch member includes a spring held in the latch cavity and extended outwards therefrom, and a circular ball butted by one end of the spring extended outwards from the latch cavity.

3. The multi-stage positioning rotary disk of claim 1, wherein the latch cavity is provided with a number of one, the latch member being latched sequentially with the corresponding positioning slots with relative turning between the outer disk and the inner disk.

4. The multi-stage positioning rotary disk of claim 1, wherein the latch cavity includes a plurality of sets, the latch members being latched sequentially with the corresponding positioning slots with relative turning between the outer disk and the inner disk.

5. The multi-stage positioning rotary disk of claim 4, wherein the latch members are latched concurrently on the positioning slots.

6. The multi-stage positioning rotary disk of claim 1, wherein the outer disk includes scale marks to indicate turning positions.

7. The multi-stage positioning rotary disk of claim 1, wherein the inner disk includes a second hole and is fastened to a seat which includes a housing space, the outer disk including a first hole run through by a round column to be fastened, the round column running through the second hole and being held in the housing space, and including a latch rim for positioning the turning positions between the inner disk and the outer disk.
